(19) United States
(12) Patent Application Publication
(10) Pub. No.: US 2010/0187352 A1
(43) Pub. Date: Jul. 29, 2010

(54) MULTI DECK AIRCRAFT

(75) Inventor: Michael Yavilevich, Kiryat Bialik (IL)

Correspondence Address: Michael Yavilevich, 5/4 Haim Street, Kiryat Bialik, 27076, omitted

(73) Assignee: Mr. Michael Yavilevich, Kiryat Bialik (IL)

(21) Appl. No.: 12/526,784

(22) PCT Filed: Jan. 29, 2008
(86) PCT No.: PCT/IB08/50317

§ 371 Date: Aug. 12, 2009

Related U.S. Application Data
(60) Provisional application No. 60/891,233, filed on Feb. 23, 2007.

(51) Int. Cl. B64C 3/00; B64D 11/06; B64D 47/00; B64D 37/04; B64C 1/22; B64D 45/00; B64D 13/02; B64C 1/06

(52) U.S. Cl. 244/36; 244/118.6; 244/118.1; 244/45 R

(57) ABSTRACT

The invention relates to multi deck passenger aircraft, having passenger cabins and/or service facilities arranged on the upper and lower deck and inner load bearing cell structure provided within aircraft body. The present invention is also directed toward methods for manufacturing derivative multi deck aircrafts. Energy absorbing, floatable cargo containers (24) attached to fuselage belly. External fuel tanks (26) displaced on the top of fuselage. Center wing region of the fuselage is using for arranging rows of seats and service facilities. Addition seating configuration for narrow and wide bodied aircraft is provided. Multi deck seating configuration significantly reduces per passenger operating cost over existing technology. Less fuel per passenger is required since there is less airframe weight and wetted area per passenger. Due to the lower overall cost per passenger seat within the multi deck seating structure, the net profit and return on investment in the aircraft are also increased.

### TECHNICAL FIELD

A present invention refers to methods and embodiments for increasing a seating capacity and an efficiency of passenger aircraft by manufacturing derivative multi deck airplanes.

### BACKGROUND ART

One problem with adding passenger seating, sleeping cabins or other passenger service facilities to cargo decks is that lower decks typically provide insufficient standing height. One attempt to overcome this problem is disclosed in U.S. Pat. No. 5,752,673 assigned to Schliwa et al. This invention discloses lowering the floor in an aisle section of the lower deck to provide at least enough clearance for a standing person of normal height.

Another problem with using lower, cargo decks for passengers is providing sufficient structure beneath the lower deck to protect passengers, in the event of a crash landing. Regulations could require at least 30 inches of compressible structure beneath the lower deck if the lower deck is to be used to carry passengers. Lowering the floor of the lower deck as proposed by Schliwa compounds this problem because it further reduces the space beneath the lower deck. One approach to meet the compressible structure requirement is disclosed in U.S. Pat. No. 5,542,626 assigned to Beuck et al. This invention discloses an energy absorbing structural unit that is attached to the underside of an aircraft fuselage.

The certification authorities' regulations stipulate that total emergency evacuation of an aircraft must be achieved within 90 seconds. The problem is even more serious if one considers the emergency evacuation of passengers, when aircraft digging on water, since big cargo doors in lower lobe decrease waterproof of conventional airliners.

The problem of dealing with terrorist bombs on board airlines has not been solved. A plastic explosive device hidden inside checked luggage stored within Unit Load Devices (ULD) in a lower cargo hold can cause a rapid breakup of the aircraft. The walls of the container would have to be inordinately thick in order to contain the explosion.

Low-wing passenger aircraft includes a large fairing in the wing-fuselage intersection, defining the lower aerodynamic surface of the fuselage in the area below the center portion of the wing that passes through the fuselage. The fairing increases the fuselage cross-section at precisely the longitudinal station where it would be desirable to reduce the fuselage cross-section, i.e., at the wing-fuselage intersection.

Still another problem with using lower cargo decks for passengers is that aircraft fuel is typically carried in fuel vessels located within the central wing box of the aircraft which engage a big space in lower fuselage lobe. The integral fuel tank must be sufficiently strong so as to tolerate the fatigue loads resulting from the motion of the airplane and from the liquid fuel splashing. There are accidents that were regrettably traced back to fires caused by kerosene leaking from an aircraft that had performed an emergency landing. Due to this, there may be a need for an aircraft having an improved fire protection by developing more safety fuel system.

Thus, in view of safety considerations and efficiency using lower lobe for passengers there is a need for relocating cargo containers from lover lobe and fuel tank from central wing box to other safety place in aircraft.

### DISCLOSURE OF INVENTION

In view of the above it is the aim of the invention to achieve the following embodiments and methods singly or in combination:

a) to increase the passenger capacity of narrow and wide-body aircrafts in a such manner that passenger cabins or service facilities located in a lower deck can also be occupied by passengers and crew members during the take-off and landing phases of a flight and a sufficient standing height for passengers is achieved at in the lower deck, while simultaneously maintaining a functional freight loading system in the external cargo containers;
b) to provide a raised portions in the upper deck floor of such an aircraft to form a passenger aisle in lower deck, having a sufficient standing height, while the lateral floor surface of the upper and lower decks is at a proper height to provide optional rows of seats arrangement;
c) to elevate passenger seats regarding aisle floor in lower cabin of twin deck narrow and wide-body aircraft, to provide maximum width and distance from fuselage belly;
d) to provide fuselage with tree-dimensional load-bearing inner cell structure included strengthened walls, thin stepped decks, ceilings and struts of upper and lower cabins and integrated with conventional semi-monocoque fuselage shell structure to maintain the integrity of the upper and lower lobes of aircraft fuselage in flight and in the event of an emergency landing;
e) to provide fuselage airframe shell primary structure comprises several longitudinally spaced, vertically oriented main ring frames, beams and angle braces to transfer the load from the fuselage shell to wings of the aircraft and undercarriage mounting;
f) to provide such an energy absorbing and safety unit that can be specifically tailored and installed on conventional aircraft having different configurations, to ensure energy absorption and protection in those areas of a lower deck to be occupied by passengers or service facilities.

According to further detailed aspects of the invention, the energy absorbing and safety unit essentially comprises a number of external, floatable cargo containers attached close to aircraft frame structure in forward and aft areas of fuselage for providing area-ruling drag reduction effect. Every container is shaped to match or fit with the outer contour of the fuselage lower deck structure and extends from fuselage belly circuit downwardly and outwardly and is shaped to have a streamlined outer contour. These containers include doors for cargo loading-unloading.

The impact energy arising during emergency landing is absorbed in a controlled manner by the cargo containers and floatable bins, whereby the chances of survival of the people on board are considerably increased because of a greater space is maintained by extending struts and walls beneath the lower deck. External floatable cargo containers and bins increase security and buoyancy of commercial aircrafts. External containers attached on the top and/or on the bottom of aircraft, to the fuselage structure, for example, by means of screws, glue, rivets, welding, or the like. With this arrangement of the cargo containers, it is possible to attach the containers to the fuselage of an existing aircraft already in service. Thus it becomes possible to after-equip or re-fit existing aircraft with passenger cabins and service spaces in a variable or adjustable manner in the lower deck space below the main deck.

According to the next embodiment of the invention, detachable, watertight external cargo containers, are connecting to the top or bottom of fuselage by conventional means like latch device operable by remote control system. The container is formed with an opening through which luggage and cargo can be placed in, or removed from.

In this invention, external cargo container will reduce the damage caused by the explosion in two manners. The container has a venting devices mounted to the outer side of the container. This allows venting of the shock waves and high pressure to the exterior of the airplane. The second manner in which damage is reduced is by constructing the container so as to withstand projectiles from being propelled through the walls of the container into the interior of the aircraft. In order to handle this problem, the container is constructed of a composite reinforced material. In a case of fire, the certain detachable container will jettison by pilots or by automatic system.

The present invention achieves other advantages by providing a cargo handling system that is capable of efficiently and effectively transporting the external cargo containers between a loading dock and an aircraft. The system is capable of providing accurate alignment of the loading dock and aircraft. In addition, the system provides cars that transport detachably external cargo containers between the loading dock and aircraft. Moreover, the system provides a variety of mechanisms and sensors that ensure that the containers are both aligned and adequately secured to the aircraft fuselage.

According to further detailed aspects of the invention, rapid evacuation of passengers following a crash on ground or water takes place laterally from upper and lower lobes, via doors used for embarking and disembarking passengers and via emergency exits from each side of the aircraft. Emergency evacuation slides are associated with these various emergency exits. These slides usually consist of inflatable structures, which are stored folded inside top and bottom external bins near upper and lower lobe emergency exits. According to embodiment of the invention, an inflatable rafts automatically deploying from the external bins near emergency exits in an emergency situation.

Another object of the present invention is to provide safety fuel system to airplanes. According to embodiment of the invention, several external fuel tanks positioned close on a top of forward and aft regions of aircraft fuselage, or in cavities of fuselage outer surface. Detachable fuel tanks have streamlined, curvilinear outer surface, which defines the aerodynamic outer surface of at least a portion of the airplane fuselage and provide area-ruling drag reduction effect. In a case of fuselage and wing damage or disintegration during emergency landing, the external fuel tanks, which are not integral with fuselage or wing structure, do not receive addition loads from other aircraft parts and will not break and leak.

The safety fuel system includes a group of external tanks having individual fuel inlet, fuel outlet, and vent manifolds. Each tank includes individual valves to control the inflow and outflow of fuel. Pneumatic pressure from an aircraft bleed air system can be individually provided to each of the tanks for fuel transfer. A single electric motor-driven fuel pump can be installed in each tank for transferring fuel out of the tank. Several external cargo containers and auxiliary fuel tanks have similar devices for connection with fuselage structure. The number and arrangement of the external auxiliary fuel tanks depends by flight range and they should be relatively easy to install and remove so that the aircraft can be quickly changed into desired configuration.

A further object of the present invention is to provide a prestressed fuselage structure constructed in such a manner that there is a minimum of fasteners through load-bearing material. According to aspects of the invention, the fuselage of commercial airplane, having inboard pressurized passenger cabin, includes load bearing airtight inner walls, enveloping said pressurized cabin area. Said internal structural skin attaching to series of longitudinal stringers connected with inboard side of the frames that encircle a cabin area. Sidewall not airtight outer skin panels are attaching to outboard side of said frames. Other aircraft components such as insulation, electrical conduits, ventilation ducting, control mechanisms, and the like installed along the inboard walls and between the frames, so that they may be enclosed between the inboard wall and the detachably curvilinear outboard panels. Preferable object of the present invention is that external, watertight fuel tanks, cargo containers and floatable bins, detachably connected with fuselage shell structure are using like curvilinear outboard panels.

According to further aspects of the invention, an airplane fuselage has a concave bottom, because of using shaped external cargo containers, for providing more lift and control at low speeds. Energy absorption structure with set of inner strut members extending along fuselage belly for providing skids for the purpose of emergency landings. The external cargo containers, placed on airplane belly and using like absorbing members are converged at the forward and rear parts of fuselage, but are spaced apart at the middle of aircraft fuselage and coincident with landing gear bays fairings, thereof to prevent an aircraft from turning to one side or the other due to direct contact with the ground or water.

In other aspect of the invention, there is providing a method for attaching aisle to lower service deck of narrow and wide body aircraft having plate in upper lobe and aperture in main deck. According this method aisle provided between walls supported plate and ladder attached to this aperture. According to this method of the invention service facilities include table or bed arranged in upper cabin on said plate. Aisle and stairs provided in lover cabin below said table plate and/or bed plate.

According to another aspect of the invention, method of increasing the seating capacity of twin deck wide body passenger aircraft, having two aisles in upper cabin and one aisle in lower cabin, by ensuring sufficient standing height in a lower cabin aisle is provided by means of manufacturing stepped upper deck structure above lower cabin aisle. The middle parts of transverse deck beams and middle floor plates are raised regarding lateral ends in a height about 5-50 cm to secure standing height about 200-250 cm in a lower cabin aisle and remaining height about 160-180 cm above rows of seats.

According to another aspect of the invention, method of increasing seating capacity of narrow and wide bodied aircraft, by building derivative multi-lobe aircraft, with fuselage having oval or number eight cross section shapes is provided by means of an increasing height of the aircraft fuselage by extending and connecting upper and lower fuselage segments lengthwise.

According to another aspect of the invention, method of increasing seating capacity of narrow and wide bodied aircraft, by building derivative very wide body aircrafts, with fuselage having width bigger then height cross section is provided by means of an increasing width of the aircraft fuselage by extending and connecting lateral fuselage segments lengthwise.

According to another aspect of the invention, method of increasing efficiency of multi-lobe aircraft, by minimizing fuselage shell thickness and weight, is provided by means of attaching struts, angle braces and walls of inner cells structure to support shell structure. Said inner load bearing cell structure compounds at least one passenger compartment with rows of seats in passenger cabin. The pitch of the struts, braces and walls is determined with respect to the spacing of the rows of seats or beds so as to ensure that each one of a majority of said struts and walls is located between adjacent seats or beds in a row to ensure maximum freedom of passenger movement between the rows.

According to another aspect of the invention, method of increasing the efficiency of commercial aircraft, by minimizing decks thickness and weight, is provided by means of manufacturing arch decks structure. The parts of transverse arch beams are hidden in overhead luggage bins.

In accordance with other aspect of the invention an aircraft has a module design with at least one forward, middle and aft fuselage regions, housing a passenger cabins. Wing passes through the middle fuselage region, having cross section area smaller then forward and aft fuselage regions. This embodiment reduces the fuselage cross-section at the wing-fuselage intersection area and contributes substantially toward reducing aircraft drag at high subsonic flight Mach numbers by providing area-ruling drag reduction effect.

The present invention is directed toward multi deck tandem wing aircraft. The rear wing is sweep aft and forward. An inlet of turbofan engine positioned before of intersection of said wing leading edges. Duct of said engine fan extend above and below of the wing upper and lower surfaces. The forward and rear wings structure integrated with fuselage shell structure and inner cell structure.

From the foregoing, it will be appreciated that specific embodiments of the invention have been described herein for purposes of illustration, but that various modifications may be made without deviating from the spirit and scope of the invention.

### BRIEF DESCRIPTION OF DRAWINGS

FIG. 1 shows side view of twin deck derivative aircraft;

FIG. 2 shows front view of twin deck derivative aircraft;

FIG. 3 shows side exploded view of twin deck derivative aircraft;

FIG. 4 shows 3D section view of two lobe narrow body aircraft with rows of seats;

FIG. 5 shows 3D section view of two lobe narrow body aircraft with wing structure;

FIG. 6 shows 3D section view of twin deck circular body aircraft with wing structure;

FIG. 7 shows 3D section view of twin deck aircraft with detachable cargo containers and fuel tanks;

FIG. 8 shows 3D section view of twin deck wide body aircraft with rows of seats;

FIG. 9 shows 3D section view of twin deck wide body aircraft with inner airtight load bearing skin;

FIG. 10 shows 3D section view of arranging aisle and stairs in lower deck;

FIG. 11 shows cross section view of aircraft with floatable cargo containers;

FIG. 12 shows plan view of tandem wing aircraft;

FIG. 13 shows cross section view of integrated wing and fuselage structure;

FIG. 14 shows cross section view of very wide multi deck aircraft;

FIG. 15 shows cross section view of multi deck aircraft with arch deck beams;

### BEST MODE FOR CARRYING OUT THE INVENTION

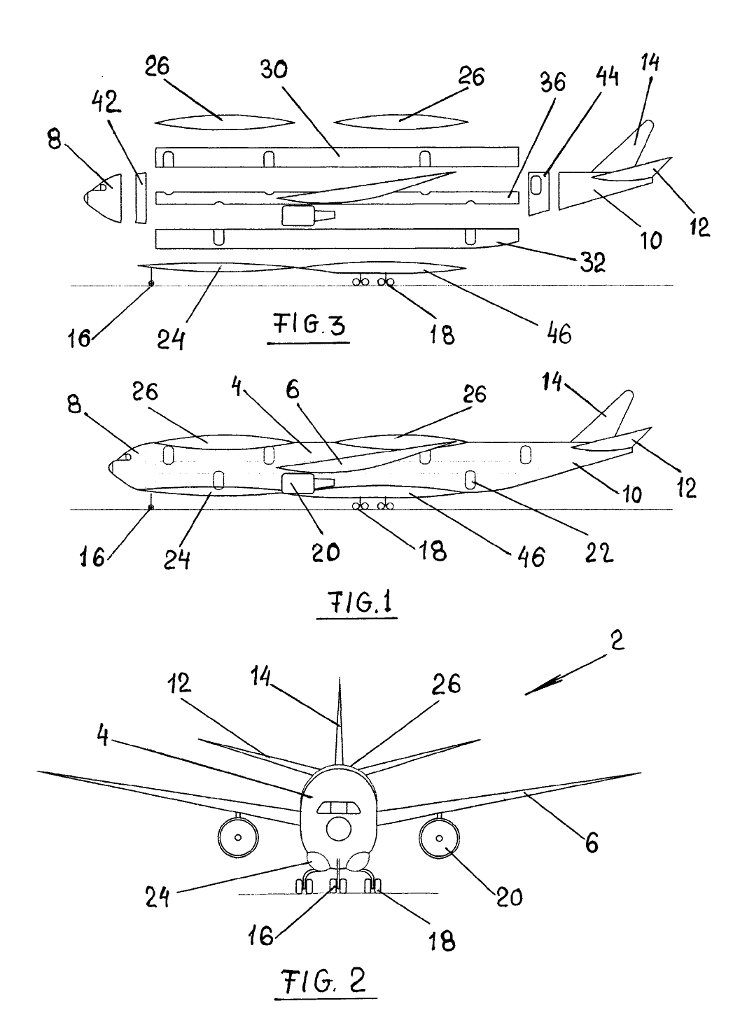

FIGS. 1 and 2 show side and front view of derivative twin deck aircraft 2. Aircraft 2 includes oval fuselage 4, wing 6, nose portion 8, tail portion 10 with horizontal 12 and vertical 14 stabilizers, forward landing gear 16, main landing gear 18 and turbofan engines 20 attached to the wing 6. Entrance and exit doors 22 and windows attached after redesign and assembling fuselage. Energy absorbing external cargo containers 24 attached to aircraft belly and external fuel tanks 26 positioned on a top of the fuselage 4, providing streamlined outer surface and increasing area-ruling drag reduction effect. The interchangeably external cargo containers 24 and auxiliary fuel tanks 26 have similar devices for connection with fuselage structure. The main landing gear 18 retracts in landing gear bays 46, shaped to have a streamlined outer contour with external containers 24. Detailed descriptions about passenger cabins show in FIGS. 4 and 8.

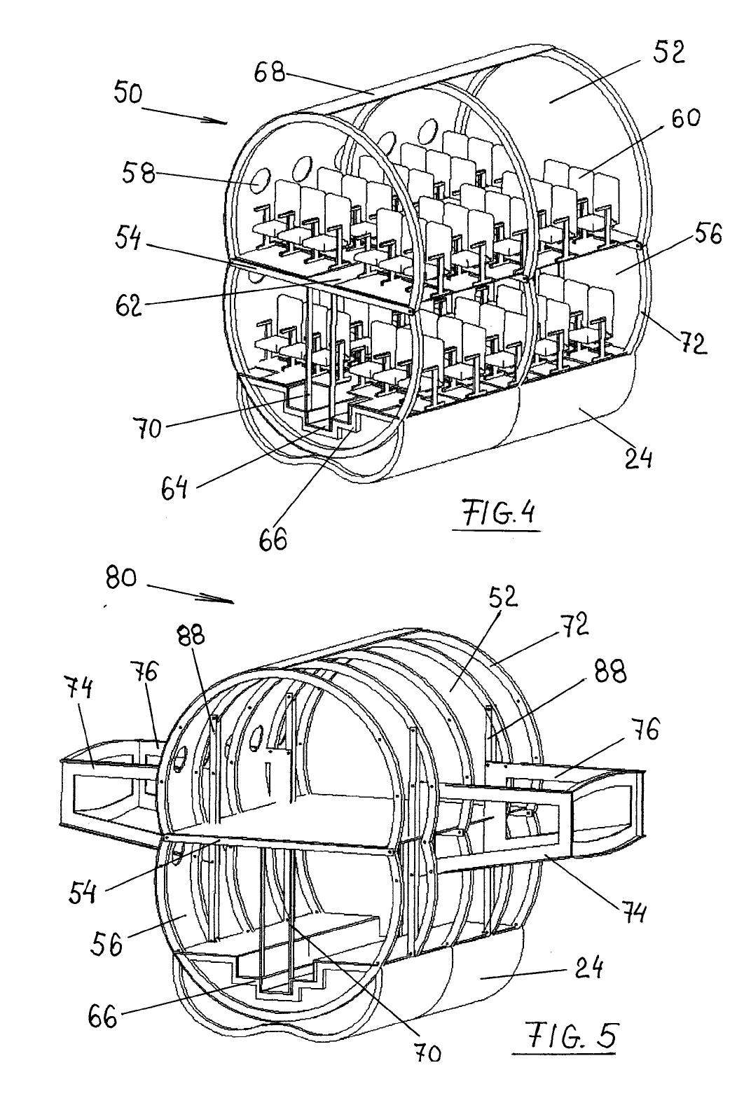

FIG. 3 shows exploded view of the method for manufacturing a derivative twin deck aircraft 2, using assemblies of conventional aircraft. These assemblies include: wing 6, nose 8 and tail 10 portions, upper 30 and lower 32 circular segments of fuselage 4. The upper 30 and lower 32 fuselage segments are assembling to a fuselage inner cells structure 34 by using connecting panels 36. The fuselage inner sells structure 34 comprising inner struts, longitudinal and transversal load bearing walls and/or decks structures. Fuselage connecting panels 36 comprising a skin and support structure, including a plurality of longitudinal stringer members and a plurality of frame members that are attached to and cooperate to support the skin. The nose 8 and tail 10 fuselage portions assembling to the central fuselage portion by using forward 42 and rear 44 combined circular-oval connection sections.

FIG. 4 shows the embodiment for twin deck narrow body passenger aircraft. Number eight cross section fuselage portion 50 contain upper passenger cabin 52 above upper deck structure 54 and lower 56 passenger cabin below upper deck structure 54. Windows 58 attaching in upper 52 and lower 56 cabins. Rows of seats 60 arranging in upper 52 and lower 56 cabins include six seats in two groups of three each on either side of passenger aisles 62 and 64. Stepped lower deck structure 66 is displaced under seats 60 in the lower cabin 56. In lower cabin 56 seats 60 raised up regarding aisle 64 to provide maximum width and distance from fuselage belly. At least a normal standing height is provided in the centre of lower deck in the areas of the aisle 64. Rows of seats 60 arranged on said stepped deck 66 region and seats near the aisle 64 having bigger leg height then near windows 58 and folding foot support providing for undersized passengers and children. Outer skin 68 partly removed to show rows of seats 60. Plurality of struts 70 connected upper 54 and lower 66 decks structure to fuselage shell structure 72. The energy absorbing external cargo containers 24 attached to aircraft belly.

FIG. 5 shows wing-fuselage intersection of twin deck derivative passenger aircraft. Fuselage portion 80 contains upper 52 and lower 56 circular shell lobes with cutting of lower and upper segments. Cutting ends of fuselage shell arches 72 connected by intersection structure. Said intersection structure reinforced in the line of junction by beams and serves like an outer boundary of upper deck 54. Wing spars 74 and 76 connected with the intersection structure of the upper 52 and lower 56 fuselage lobes by plurality of beams 88. Said beams 88 and spars 74 and 76 comprise lateral spar boxes. Fuselage arches 72, upper 54 and lower 66 decks structure, inner struts 70 and the beams 88 comprise middle wing box, embracing upper 52 and lower 56 lobes and integral with fuselage airframe shell structure and lobes intersection structure. Said lateral and middle wing boxes uses as space for placing rows of seats, galleys and/or service facilities in upper 52 and lower 56 passenger cabins. Set of struts 70 provides additional support to the fuselage 4 and in particular, to the upper 54 and lower 66 decks stepped structures. Energy absorbing cargo containers 24 attached to the aircraft frame structure 72. In this manner, the strength and integrity of the supporting structure is maintained during emergency landing. Latch means, operable by remote control devises, provided for detachably securing the containers 24 to the fuselage.

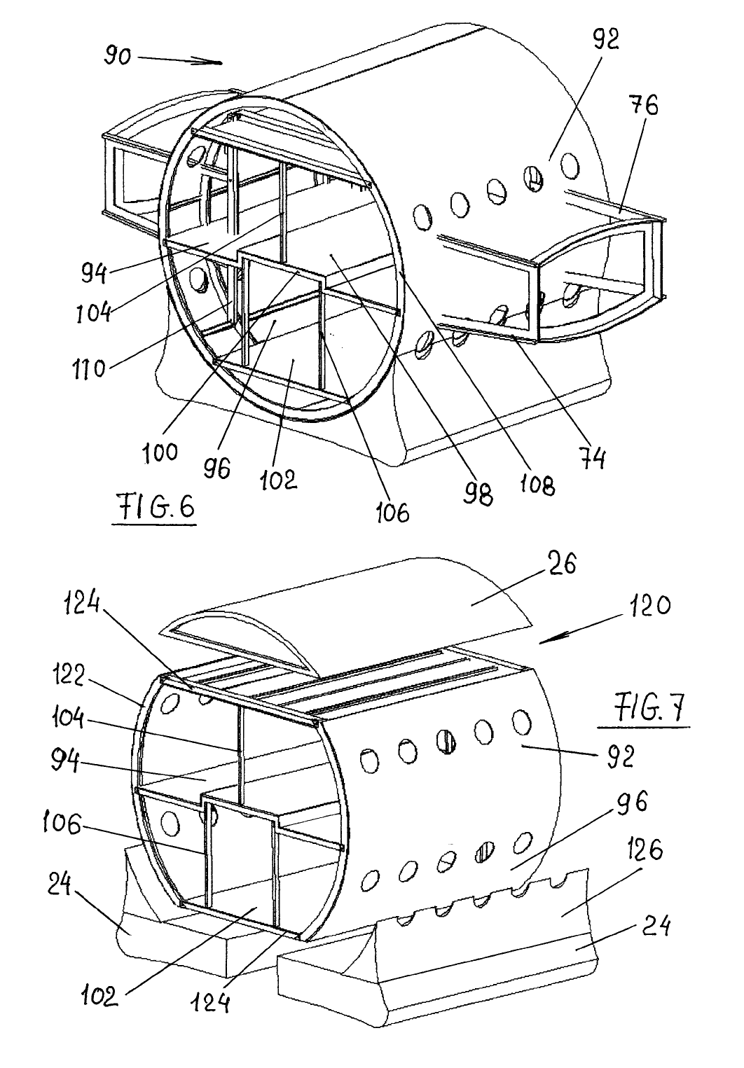

FIG. 6 relates to a derivative twin deck wide body aircraft, having circular fuselage cross section. Fuselage portion 90 contains upper passenger cabin 92 displaced above upper deck 94 and lower passenger cabin 96 displaced below upper deck 94. Each of the cabins 92 and 96 being vertically spaced apart such that each of the decks is equally suitable for carrying passengers or cargo without significant changing in fuselage design. The upper deck structure 94 essentially comprises a grid-like framework of lengthwise and cross-wise girders on which floor panels and the typical functional components of the seats connection system, are arranged. The upper deck 94 is raised in central area 98, so that a normal standing height of a passenger is provided in the lower cabin 96. Cross-wise stepped girders 100 of the upper deck 94 extends up on height of one or two steps, whereby side shanks of the girders 100 extends in the direction of the fuselage shell structure 108. Plurality of struts 104 and 106 connected upper 94 and lower deck 102 with fuselage shell structure 108. Wing spars 74 and 76 are connected with the fuselage shell structure 108 and a number of internal beams 110. Space near said beams 110 and spars 74 and 76 uses for placing rows of seats, galleys and/or for service facilities in the upper and lower passenger cabins.

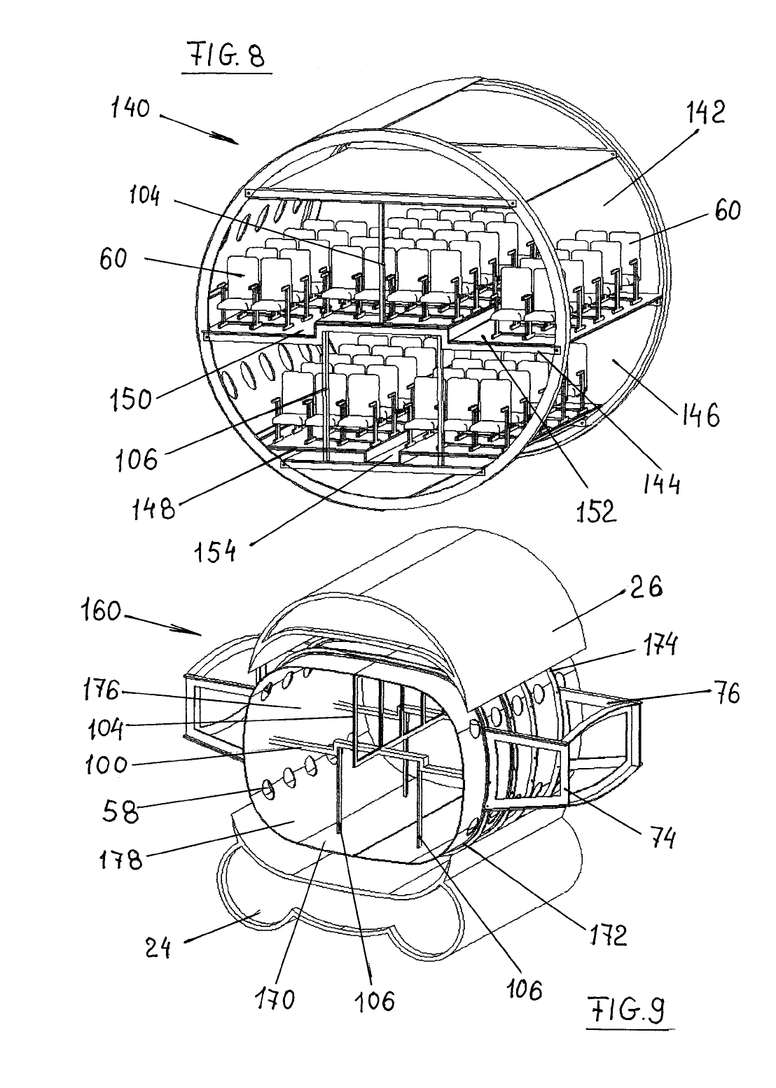

FIG. 7 relates to a twin deck wide-body aircraft, having a circular fuselage cross section portion 120 with cutting of upper and lower segments for arranging external fuel tanks 26 on the top and detachable floatable cargo containers 24 on the bottom of the fuselage portion 120. Cutting ends of fuselage shell arches 122 connected by beams 124. Upper beams 124 are coincident with an upper cabin 92 ceiling and the lower beams 124 are coincident with lower deck 102. Plurality of struts 104 and 106 connected upper 94 and lower 102 decks with beams 124. Several external bins 126 attached closely to the underside of an aircraft fuselage. Said bins 126 shaped to have a streamlined outer contour with external cargo containers 24 and landing gear bays 46. Bins 126 may comprise retractable stairs for embarking and disembarking passengers via the lower lobe doors and evacuation slides and inflatable rafts which are stored folded and automatically deploying in an emergency situation near upper and lower lobe emergency exits. Detailed description about bins 126 is shown in FIG. 11.

FIG. 8 shows the embodiment for twin deck wide-body passenger aircraft having circular fuselage cross section. Fuselage portion 140 contains an upper passenger cabin 142 displaced above upper deck 144 and lower 146 passenger cabin displaced below upper deck 144. Rows of seats 60 are arranging in upper 142 and lower 146 cabins. In upper cabin 142 seat sections can include seating rows having eight seats 60 abreast, arranged in three groups of 2+4+2 separated by left and right longitudinal aisles 150 and 152. The aisles 150 and 152 extend lengthwise through upper deck 144. In lower cabin 146 seat section includes seating rows having six seats 60 arranged in two groups on either side of an aisle 154. In lower cabin seats 60 raised up regarding aisle 154 to provide maximum width and distance from fuselage belly. Set of struts 104 and 106 provides additional structural support to the fuselage and in particular, to stepped lower deck structure 148 displaced under seats 60 in the lower cabin 146. The arrangement of the struts 104 and 106 along two lobes endows the fuselage with the necessary resistance to internal pressure and to dynamic stresses and offer complete freedom of passenger movement within the cabins.

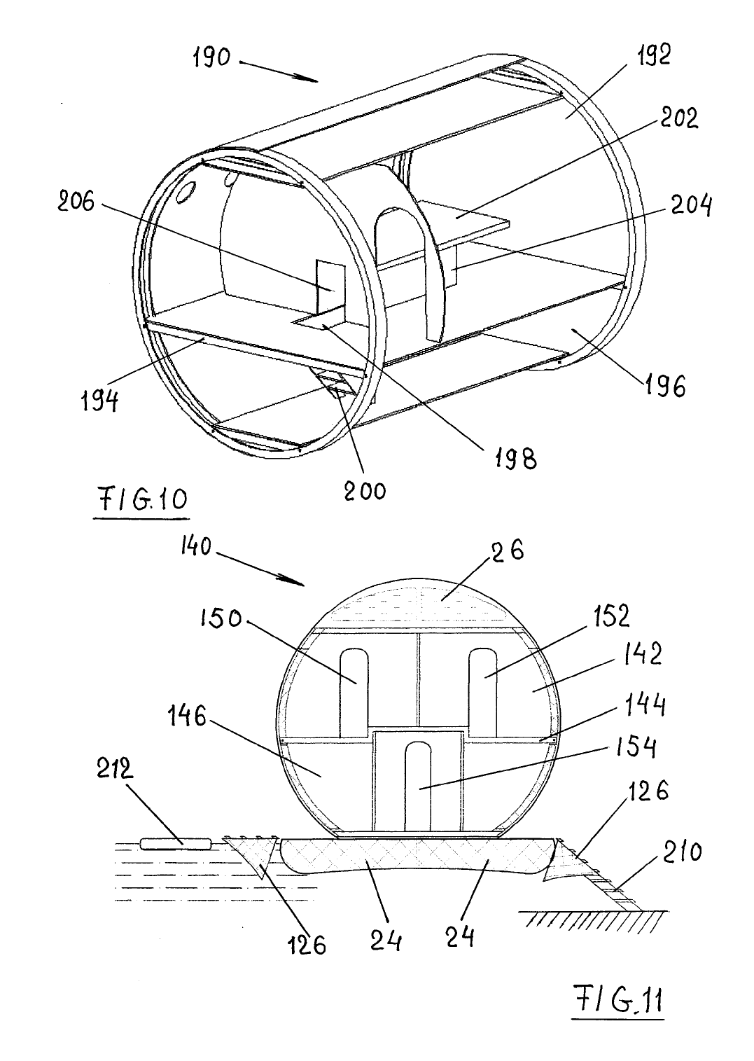

FIG. 9 shows the embodiment for twin deck wide-body passenger aircraft having resembled rectangle oval cross section fuselage. Cross section contour of fuselage portion 160 consist of one top and one bottom arcs, two lateral arcs and four arcs connecting lateral arcs with top and bottom arcs. Fuselage portion 160 comprising inboard pressurized upper 176 and lower 178 cabins with inner airtight walls 170. Inner airtight load-bearing walls or inner skin 170, are attached inside fuselage shell primary structure 172. Said inner walls 170 envelop inboard pressurized cabins 176 and 178. Fuselage shell outer structure 172 includes a series of vertically oriented frames 174 that encircle a cabins 176 and 178 and a series of longitudinal stringers connected with said frames 174. Inboard airtight walls 170 attached to longitudinal stringers and said stringers attached with inboard side of the frames 174 of shell structure 172. Inner airtight wall 170 attached between the inner fuselage cell structure includes deck beams 100 and struts 104 and 106 and series of outer vertically oriented frames 174. In this embodiment a minimum of fasteners through load-bearing walls 170 required. Sidewall, not airtight outer skin panels 168 attached to outboard side of the frames 174 to provide curvilinear external fuselage contour. Outer skin 168 tighten around the shell frames 174 and press the inner skin 170 towards inner cell structure to provide prestressed fuselage structure, to withstand hoop stresses from inner skin pressure differential. It is preferable to use external fuel tanks 26, cargo containers 24 and other detachable compartments like outer skin panels. Other aircraft components such as insulation, electrical conduits, ventilation ducting, control mechanisms and the like may be enclosed between the inboard wall 170 and the detachably curvilinear outboard skin panels 168. Windows 58 extend through the space between the inner skin 170 and outboard skin panels 168. Wing spars 74 and 76 connected with fuselage shell structure 172 and number of upper deck beams 100.

With reference to FIG. 10 the principle for providing additional service facilities in twin deck aircraft explained. Fuselage portion 190 contains upper passenger cabin 192 and lower service cabin 196. Upper deck 194 has an aperture 198. Stairs 200 attaching near said aperture 198, providing access from the upper cabin 192 to the lower cabin 196 using narrow passage 206 under table plate 202 placed in the cabin 192. Walls 204 support the table plate 202 and embrace the passage 206 under the table plate 202. This embodiment increases space for service facilities in the cabins 192 and 196.

FIG. 11 shows the embodiment for floatable cargo containers 24 attached to fuselage belly. Fuselage portion 140 contains an upper passenger cabin 142 displaced above upper stepped deck 144 and a lower 146 passenger cabin displaced below the upper deck 144. The upper cabin 142 has isles 150 and 152 and the lower cabin 146 has isle 154. Floatable cargo containers 24 provide ability for safety emergency landing on ground or water. Above said containers 24 attached several swinging out bins 126 comprising retractable stairs 210 for embarking and disembarking passengers via the lower lobe doors. Some float bins 126 include evacuation slides and inflatable rafts 212 which are stored folded and automatically deploying in an emergency situation near emergency exits.

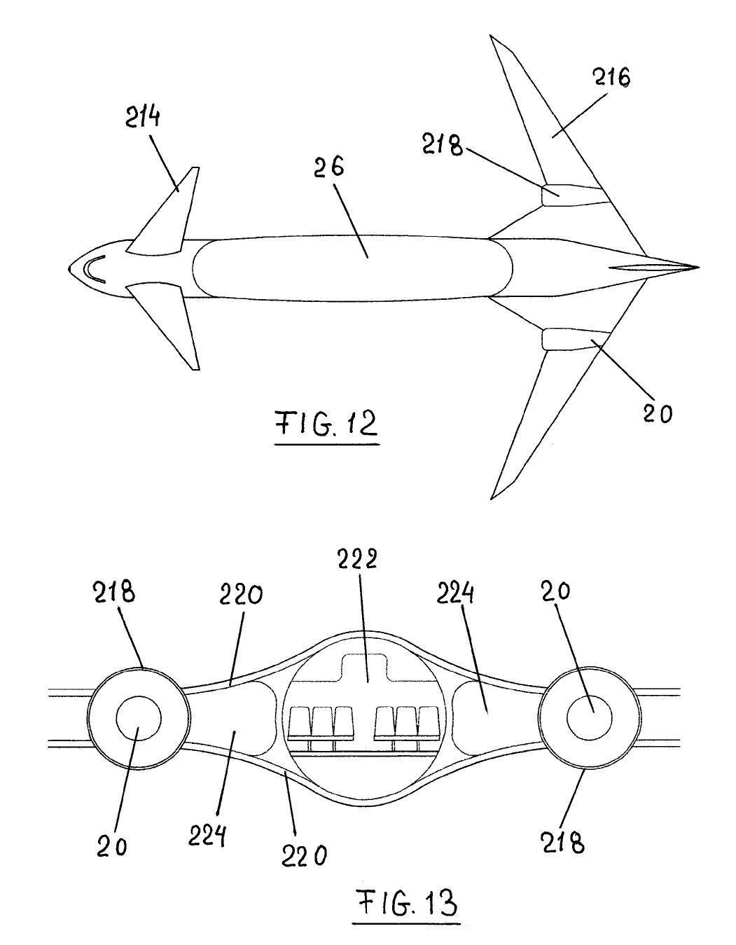

FIG. 12 shows top view of an aircraft with tandem forward 214 and rear 216 wings. The rear wing 216 is sweep aft and forward. Wing portion near fuselage has leading edge sweeping back, middle and lateral wing portions have leading edge sweeping forward. Pair turbofan engines 20 partly arranged inside the rear wing 216 in areas of the leading edges intersection. Inlets 208 of turbofan engines 20 positioned before of intersection of said wing leading edges. Fan duct 218 of said engine 20 extend above and below of the wing upper and lower surfaces. The forward and rear wings structures integrated with fuselage shell structure and inner cells load-bearing structure. Several external fuel tanks 26 displaced on a top of fuselage 4 between the wings.

FIG. 13 shows cross section view of integrated wing and fuselage portion, having turbofan engines 20 partly arranged inside the wing. In this embodiment compressor and turbine of said engines 20 displaced inside wing structure 220, but fan ducts 218 extends from the wing upper and lower surfaces. Wing structure 220 embraces passenger cabin 222, having smaller cross section area in a vicinity of the wing then in other fuselage regions. Inner wing region 224 connected with fuselage region and uses for displacing service facilities.

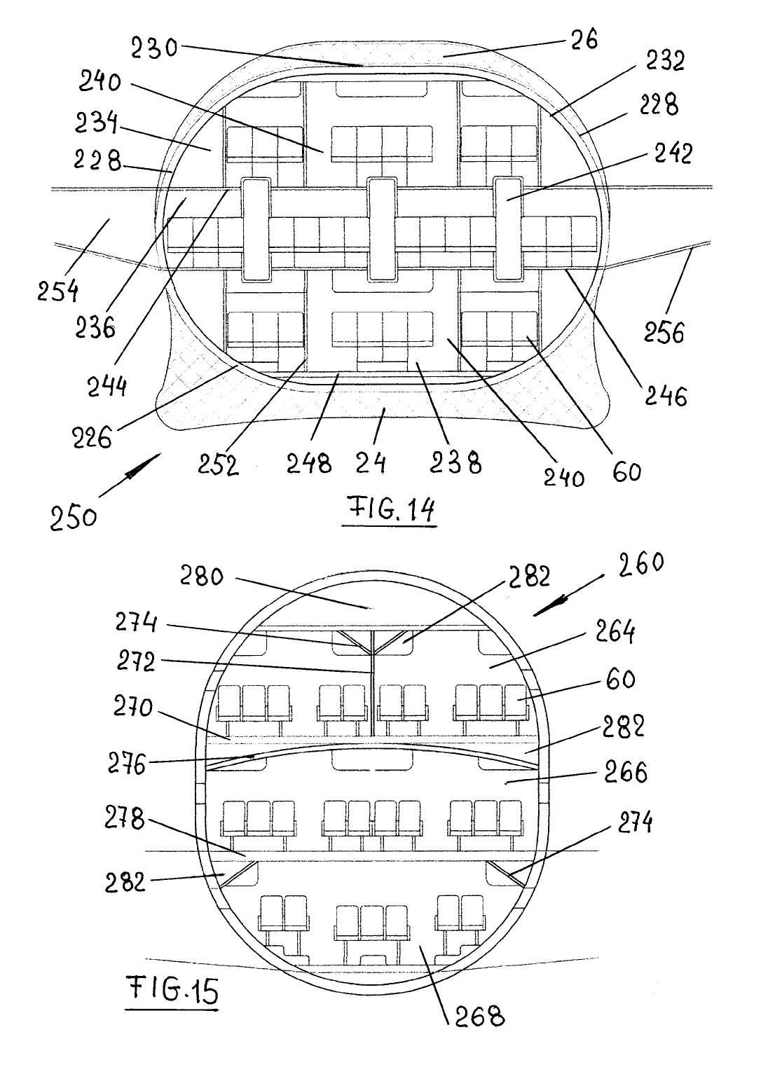

FIG. 14 shows passenger cabins of three decks very wide, oval body aircraft. Fuselage portion 250 has width around 8-9 meters and height 6-7 meters. Said portion 250 has an outer shell 226 structure, comprises lateral circular segments 228 and upper and lower connecting panels 230. Preferably embodiment has inner airtight load bearing walls 232 regarding to embodiment shown in FIG. 9. Fuselage portion 250 has three passenger and/or cargo cabins spaced vertically. Upper 234 and lower 238 cabins have at least two longitudinal aisles 240 and middle cabin 236 has at least three longitudinal aisles 242. Said airplane has thin stepped upper 244, middle 246 and lower 248 decks and ceiling structures integrated with fuselage outer shell 226. Stepped decks provide sufficient standing height in the upper, middle and lower cabin aisles 240, 242 and smaller height above rows of seats 60. In upper 234 and lower 238 cabins seat sections can include seating rows having ten seats 60 abreast, arranged in three groups separated by left and right longitudinal aisles 240. In middle cabin 236 seat sections can include seating rows having fourteen seats 60 abreast, arranged in four groups separated by left, middle and right longitudinal aisles 242. Seats near the aisles have bigger leg height then other seats. Plurality of struts and/or load bearing longitudinal and transverse inner walls 252 support thin upper 244, middle 246 and lower 248 decks and connected said decks with fuselage shell structure 226 to form rigid cells structure. A wing unit 254 passes through the fuselage middle region. Wing spars 256 integrated and coincident with upper 244 and middle 246 decks structures. Rows of seats 60 arranged in a central wing area. In preferable embodiment aircraft has middle region with width smaller then forward and aft regions. Minimizing fuselage width at the wing-fuselage intersection area contributes substantially toward reducing aircraft drag at high subsonic flight Mach numbers because of area-ruling drag reduction effect. External fuel tanks 26 positioned close to a top of the fuselage, providing streamlined outer surface to the fuselage. External cargo containers 24 configured to fit with fuselage belly and define fuselage outer surface during normal operation of the aircraft and during water landing. This embodiment has cross section area similar to Airbus 380 and can accommodate 34 passengers in one cross section in three decks or 24 passengers in one cross section in upper and middle decks and cargo in lower deck.

FIG. 15 shows a fuselage portion 260 of elliptical wide-body aircraft, similar to Airbus 380. Two addition passenger seats 60 providing in upper cabin 264 because of lowering upper deck 270. Girder 272 and/or plurality of angle braces 274 support upper cabin 264 ceiling. Plurality of arch beams 276 supports upper deck 270 structure. Plurality of angle braces 274 support thin middle deck 278 structures. Space 280 above upper cabin 264 is using for cables and ducts. Inside passenger cabins angle struts 274 and arch beams 276 are hidden within overhead bins 282. The strength and integrity of the supporting structure is maintained despite the decreasing the thickness and weight of upper and middle decks structures.

### INDUSTRIAL APPLICABILITY

The possibility of employing partial structures of pre-existing cylindrical shells constitutes an essential advantage of the invention since this avoids the need to undertake a very large number of studies and to design new tool components. Production costs may be substantially reduced by making use of parts which already exist in other types of aircrafts. Similarly, it is an advantage to manufacture aircraft having identical subassemblies comprising many common parts since initial production tooling costs may accordingly be amortized over a larger series.

1. An aircraft for transporting passengers and cargo having a fuselage, a wing, a landing gear and other conventional assemblies, said fuselage has an airframe shell structure and includes at least one cabin for accommodating passengers, said at least one cabin has at least one aisle having sufficient standing height, wherein the fuselage has an inner load-bearing cell structure connected to the fuselage airframe shell to enable the fuselage to withstand operational stresses and an internal pressurization, said inner load-bearing cell structure compounds at least one passenger compartment with rows of seats in said at least one passenger cabin, a pitch of the struts, beams, angle braces and load-bearing walls, composing said inner cell structure, is determined with respect to spacing of rows of seats and/or beds so as to ensure that the load-bearing cell structure is located between adjacent seats and/or beds to ensure maximum freedom of movement between the rows.

2. (canceled)

3. (canceled)

4. (canceled)

5. (canceled)

6. (canceled)

7. (canceled)

8. The aircraft according to claim 1 having circular or oval cross section fuselage, said fuselage has at least two passenger cabins spaced vertically, wherein at least one portion of an upper deck floor structure elevated lengthwise at least one step, above a lower cabin aisle, to provide sufficient standing height in a lower cabin; lateral portions of a lower cabin deck structure are elevated at least one step regarding aisle portion and rows of seats and/or service facilities arranged on the said elevated portions of upper and lower decks.

9. (canceled)

10. (canceled)

11. (canceled)

12. (canceled)

13. The aircraft according to claim 1 with circular or oval cross section fuselage, having at least three passenger and/or cargo cabins spaced vertically, wherein said airplane has stepped upper, lower and middle decks floor and ceiling structures, an aisle portion of the upper deck structure is lowered lengthwise above middle cabin rows of seats; at least one portion of a middle cabin ceiling are elevated lengthwise above the middle deck aisle and lateral rows of seats, at least one portion of the middle deck structure are lowered lengthwise and aisles, rows of seats and/or service facilities arranged on said middle deck lowered portion.

14. The aircraft according to claim 1, is blended wing body airplane, having fuselage with forward, middle and aft regions, a wing unit is integrated with the fuselage middle region, said wing has curvilinear spars structure embraced passenger cabin in the middle region, wherein a fuselage cross section area in the middle region is smaller than in front and aft regions and said middle region uses for placing rows of seats and for service facilities.

15. The aircraft according to claim 1 with circular or oval cross section fuselage, said fuselage has at least two passenger cabins spaced vertically, at least one passenger cabin has stepped deck structure, wherein at least one portion of a stepped deck structure is elevated twice, regarding an aisle region, and the rows of seats arranged on said stepped deck regions and the seats near the aisle having bigger leg height than near window seats and folding foot-supports providing for undersized passengers and children.

16. (canceled)

17. (canceled)

18. The aircraft according to claim 1, having at least two passenger cabins spaced vertically, comprises a wing unit that passes through the passenger cabin or through a load-bearing cabins intersection structure, the said wing unit includes an integral with fuselage central wing box located within the passenger cabin, wherein wing spars connected to fuselage shell circular beams and inner vertical beams, connected to said circular beams and the said wing box is using as space for placing rows of seats and/or for service facilities in the passenger cabin.

19. (canceled)

20. An aircraft for transporting passengers and cargo has at least one external, watertight cargo container and/or fuel tank, attached closely to an aircraft fuselage and/or placed in a cavities of forward and aft regions of the aircraft fuselage, said at least cargo container and/or fuel tank has a streamlined outer contour, wherein a curvilinear outer boundary of said cargo container and/or fuel tank extends from the fuselage outer, tubular contour in front and rear fuselage regions, to provide reduced cross-section area at the wing-fuselage intersection region to receive area-ruling drag reduction effect.

21. The cargo containers according to claim 20 converged at forward and rear parts of a fuselage, but spaced apart in a middle of an aircraft belly and coincident with landing gear bays fairing, to provide a concave bottom and to generate more lift and control at low speed; wherein said containers are using like energy absorbing unit during emergency landing on the ground or water.

22. The cargo container according to claim 20 manufactured from reinforced composite materials and does not constitutes a structural part of the airplane fuselage and wing, wherein said at least one cargo container has at least one venting device mounted on an outer side of the container to direct shock waves and high pressure to an exterior of the aircraft in a case of a bomb explosion inside the container.

23. The aircraft according to claim 20 has at least one detachable external cargo container, connected to an aircraft fuselage shell structure, said at least one container has doors for placing luggage inside and latch means, operable by remote control devises, for detachably securing the container to the fuselage structure, wherein airport system is provided for loading and unloading these external cargo containers.

24. (canceled)

25. (canceled)

26. The aircraft according to claim 1 has at least one external floatable bin attached closely to a fuselage and coincident with external cargo containers, wherein said bin comprises: retractable stairs for embarking and disembarking passengers via lower lobe doors and evacuation slides and inflatable rafts which are stored folded and automatically deploying in an emergency situation near upper and lower lobe emergency exits.

27. (canceled)

28. The safety external fuel tank according to claim 20, manufactured from reinforced composite materials and does not constitutes a structural part of an aircraft fuselage and wing, has at least one sensor and valve for disconnecting external fuel tank from the aircraft fuel line, to prevent fuel leaking during crash landing.

29. (canceled)

30. The aircraft according to claim 20, has a number of interchangeably external cargo containers and auxiliary fuel tanks, having similar devices for connection with a fuselage structure, wherein a number and arrangement of the external cargo containers and the auxiliary fuel tanks depends by flight range and the cargo containers and the fuel tanks should be relatively easy to install and remove so that the aircraft can be quickly changed into a desired configuration.

31. The aircraft according to claim 1 has a fuselage with at least one internally pressurized passenger cabin, said cabin comprising inner load-bearing, airtight walls or inner skin, wherein said inner skin attached between a fuselage inner cell structure and inboard side of a fuselage shell airframe structure and envelope said passenger cabin, wherein sidewall, not airtight outer skin panels brace outboard side of the airframe shell structure towards inner cell structure, to withstand hoop, tension stresses from inner skin pressure differential, wherein said outer skin bands consist of a fiber-reinforced composite material.

32. (canceled)

33. (canceled)

34. (canceled)

35. The aircraft fuselage according to claim 31 has inner airtight skin and outer not airtight skin panels, wherein at least one curvilinear outboard skin panel is external, watertight cargo container, fuel tank and floatable bin, detachably connected with fuselage shell structure and forming a streamlined outer fuselage contour.

36. The aircraft fuselage according to claim 31, includes forward, middle and aft regions with different cross sections, having several internally pressurized passenger cabins, said cabins connected by their shell structure and inner load-bearing cell structure; wherein stepped longitudinal, internal airtight walls, enveloping longitudinal pressurized cabins area, wherein outboard not airtight skin panels, external cargo containers and external fuel tanks, attached closely to an aircraft fuselage, shaping a streamlined fuselage outer contour.

37. (canceled)

38. (canceled)

39. (canceled)

40. The aircraft according to claim 1, is a tandem wing aircraft includes a forward wing extends outwardly from the lower portion of the fuselage and a rear wing sweeps aft and forward, wherein at least one pair of turbofan engines placed inside said rear wing structure in a vicinity of a leading edges intersection and turbofan ducts extend forward, up and down regarding a wing contour.

41. The aircraft according to claim 1, consists of an upper and lower cabins, an upper deck has at least one aperture with interior stairway for access from one cabin to another, a table, a bed or other service facilities is displaced on a plate above the aperture in upper deck, wherein a lower cabin aisle arranged in this aperture, between walls supported this plate.

42. (canceled)

43. The aircraft according to claim 1, wherein assembling prestressed fuselage structure for increasing an efficiency of an aircraft, by minimizing a fuselage shell thickness and weight is provided by steps: a) manufacturing a fuselage inner load-bearing cell structure, b) connecting inner load-bearing, airtight walls or inner skin, between the fuselage inner cell structure and inboard side of a fuselage shell airframe structure, c) bracing sidewall, not airtight outer skin circular bands around outboard side of the airframe shell structure, wherein static compressive stress of outer skin offsets the tensile stress creating in inner skin by pressure differential.

44. (canceled)

45. (canceled)

46. (canceled)

47. (canceled)

48. (canceled)

49. (canceled)

50. An aircraft for transporting passengers and cargo has at least one deck, connected to a fuselage airframe shell, wherein the deck has transverse arch beams, to minimize decks thickness and weight, wherein connection parts of transverse arch beams and airframe shell are hidden in overhead luggage bins.

51. (canceled)

52. (canceled)

53. (canceled)

54. (canceled)

55. (canceled)

56. (canceled)

57. (canceled)

58. (canceled)

59. (canceled)
